(19) United States
(12) Patent Application Publication
(10) Pub. No.: US 2022/0329494 A1
(43) Pub. Date: Oct. 13, 2022

(54) SYSTEM, METHOD, AND CONTROL APPARATUS

(71) Applicant: NEC Corporation, Minato-ku, Tokyo (JP)

(72) Inventors: Anan SAWABE, Tokyo (JP); Takanori IWAI, Tokyo (JP); Kosei KOBAYASHI, Tokyo (JP)

(73) Assignee: NEC Corporation, Minato-ku, Tokyo (JP)

(21) Appl. No.: 17/642,719

(22) PCT Filed: Sep. 30, 2019
(86) PCT No.: PCT/JP2019/038458

§ 371 Date: Mar. 14, 2022

(51) Int. Cl. H04L 41/16; H04L 43/0876

(52) U.S. Cl. CPC H04L 41/16; H04L 43/0876

(57) ABSTRACT

In order to more easily perform communication control suitable for a communication environment in a communication network, a system according to an aspect of the present disclosure includes: an obtaining means for obtaining state information related to a state of a communication network; and a selecting means for selecting one of a plurality of machine learning based controllers for controlling communication in the communication network, based on the state information.

### BACKGROUND

### Technical Field

The present disclosure relates to a system, a method, and a control apparatus.

### Background Art

In a network in which a communication environment changes, automatically configuring a control parameter suitable for the communication environment is extremely important. As a method for automatically configuring the control parameter, machine learning is expected. As a type of the machine learning, reinforcement learning has been known.

For example, PTL 1 describes a technique of using reinforcement learning for automatically configuring a control parameter of a radio communication network.

### CITATION LIST

### Patent Literature

PTL 1: JP 2013-026980 A

### SUMMARY

### Technical Problem

For example, as a simple method, performing machine learning by using a single machine learning based controller and automatically configuring a control parameter suitable for a communication environment is conceivable.

However, since appropriate control parameters differ for each communication environment, using a single machine learning based controller in a network (for example, a radio network) in which a communication environment changes may take a large amount of time in detecting an optimal control parameter and converging of a control parameter. Further, even if the control parameter converges, accuracy of the converged control parameter may be reduced.

An example object of the present disclosure is to provide a system, a method, and a control apparatus that more easily perform communication control suitable for a communication environment in a communication network.

### Solution to Problem

A system according to an aspect of the present disclosure includes: an obtaining means for obtaining state information related to a state of a communication network; and a selecting means for selecting one of a plurality of machine learning based controllers for controlling communication in the communication network, based on the state information.

A method according to an aspect of the present disclosure includes: obtaining state information related to a state of a communication network; and selecting one of a plurality of machine learning based controllers for controlling communication in the communication network, based on the state information.

A control apparatus according to an aspect of the present disclosure includes: an obtaining means for obtaining state information related to a state of a communication network; and a selecting means for selecting one of a plurality of machine learning based controllers for controlling communication in the communication network, based on the state information.

### Advantageous Effects of Invention

According to the present invention, communication control suitable for a communication environment can be more easily performed in a communication network. Note that, according to the present invention, instead of or together with the above effects, other effects may be exerted.

### BRIEF DESCRIPTION OF THE DRAWINGS

FIG. 1 is a diagram for illustrating an overview of reinforcement learning;

FIG. 2 is a diagram for illustrating an example of a Q table;

FIG. 3 is a diagram illustrating an example of a schematic configuration of a system according to a first example embodiment;

FIG. 4 is a block diagram illustrating an example of a schematic functional configuration of a control apparatus according to the first example embodiment;

FIG. 5 is a block diagram illustrating an example of a schematic hardware configuration of the control apparatus according to the first example embodiment;

FIG. 6 is a diagram for illustrating an example of a learning condition of each machine learning based controller according to the first example embodiment;

FIG. 7 is a diagram for illustrating an example of a configuration of a neural network according to the first example embodiment;

FIG. 8 is a flowchart for illustrating an example of a general flow of controller selection processing according to the first example embodiment;

FIG. 9 is a diagram for illustrating an example of a method of determination of a state of a communication network according to the first example embodiment;

FIG. 10 is a diagram for illustrating an example of operation of the control apparatus according to the first example embodiment;

FIG. 11 is a diagram for illustrating a first example of the operation of the control apparatus according to a fourth example alteration of the first example embodiment;

FIG. 12 is a diagram for illustrating a second example of the operation of the control apparatus according to the fourth example alteration of the first example embodiment;

FIG. 13 is a diagram for illustrating a third example of the operation of the control apparatus according to the fourth example alteration of the first example embodiment;

FIG. 14 is a diagram illustrating an example of a schematic configuration of a system according to a second example embodiment; and

FIG. 15 is a flowchart for illustrating an example of a general flow of controller selection processing according to the second example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. Related Art

2. First Example Embodiment
2.1. Configuration of System
2.2. Configuration of Control Apparatus
2.3. Features of Machine Learning Based Controller
2.4. Selection of Machine Learning Based Controller
2.5. Example Alterations

3. Second Example Embodiment

### 1. Related Art

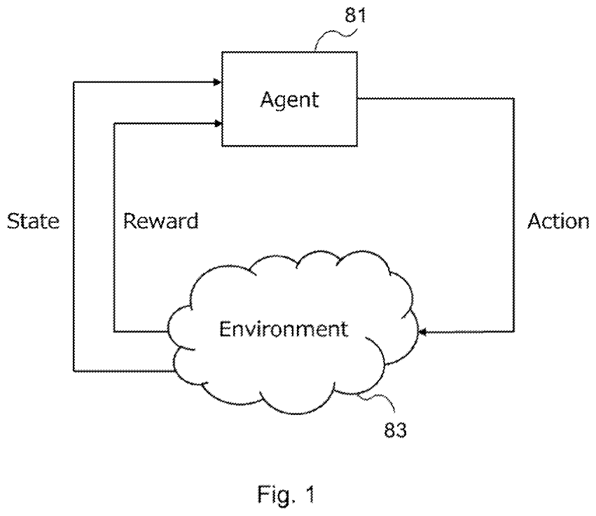

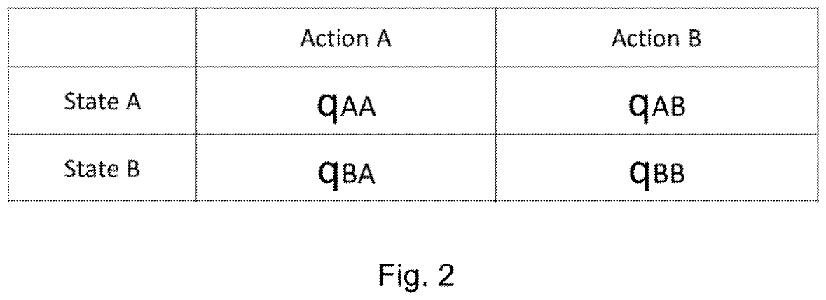

With reference to FIG. 1 and FIG. 2, as a technique related to an example embodiment of the present disclosure, reinforcement learning being a type of machine learning will be described.

FIG. 1 is a diagram for illustrating an overview of reinforcement learning. With reference to FIG. 1, in reinforcement learning, an agent 81 observes a state of an environment 83, and selects an action from the observe state. The agent 81 obtains a reward from the environment 83 through selection of the action under the environment. Through repetition of such a series of operations, the agent 81 can learn what kind of action brings out the greatest reward according to the state of the environment 83. In other words, the agent 81 can learn an action to be selected according to the environment in order to maximize the reward.

An example of reinforcement learning is Q learning. In Q learning, for example, a Q table is used, which indicates how high value each action has regarding each state of the environment 83. The agent 81 selects an action according to a state of the environment 83 by using the Q table. In addition, the agent 81 updates the Q table, based on the reward obtained according to selection of the action.

FIG. 2 is a diagram for illustrating an example of the Q table. With reference to FIG. 2, the states of the environment 83 include state A and state B, and the actions of the agent 81 include action A and action B. The Q table indicates value when each action is taken in each state. For example, the value of taking action A in state A is q_{AA}, and the value of taking action B in state A is q_{AB}. The value of taking action A in state B is q_{BA}, and the value of taking action B in state B is q_{BB}. For example, the agent 81 takes an action having the highest value in each state. As an example, when q_{AA} is higher than q_{AB}, the agent 81 takes action A in state A. Note that the value (q_{AA}, q_{AB}, q_{BA}, and q_{BB}) in the Q table is updated based on the reward obtained according to selection of the action.

In reinforcement learning, taking an action having the highest value in each state described above is referred to as “exploitation (use)”. When learning is performed only by “exploitation”, learning results may be a local optimal solution instead of an optimal solution because the action that can be taken in each state is limited. Thus, in reinforcement learning, learning is performed by “exploitation” and “exploration (search)”. “Exploration” means that an action randomly selected in each state is taken. For example, in the Epsilon-Greedy method, “exploration” is selected with probability ε, and “exploitation” is selected with probability 1−ε. With “exploration”, for example, in a certain state, an action with unknown value is selected, and as a result, value of the action in the certain state can be known. Owing to such “exploration”, it is more likely that an optimal solution may be obtained as the learning results.

### 2. First Example Embodiment

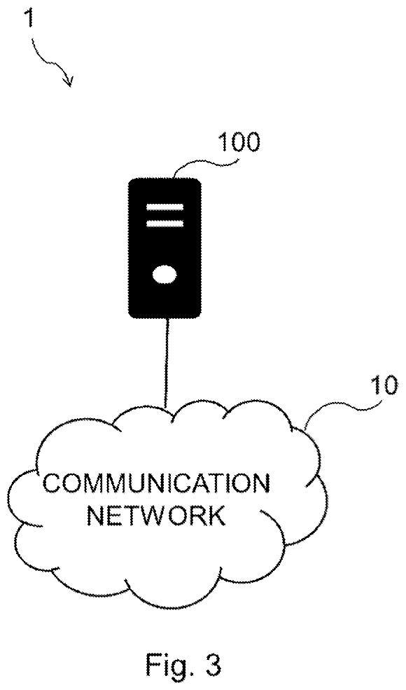

With reference to FIG. 3 to FIG. 9, a first example embodiment of the present disclosure will be described.

<2.1. Configuration of System>

FIG. 3 illustrates an example of a schematic configuration of a system 1 according to the first example embodiment. With reference to FIG. 3, the system 1 includes a communication network 10 and a control apparatus 100.

(1) Communication Network 10

The communication network 10 transfers data. For example, the communication network 10 includes network devices (for example, a proxy server, a gateway, a router, a switch, and/or the like) and a line, and each of the network devices transfers data via the line.

The communication network 10 may be a wired network, or may be a radio network. Alternatively, the communication network 10 may include both of a wired network and a radio network. For example, the radio network may be a mobile communication network using the standard of a communication line such as Long Term Evolution (LTE) or 5th Generation (5G), or may be a network used in a specific area such as a wireless local area network (LAN) or a local 5G. The wired network may be, for example, a LAN, a wide area network (WAN), the Internet, or the like.

(2) Control Apparatus 100

The control apparatus 100 performs control for the communication network 10.

For example, the control apparatus 100 includes a plurality of machine learning based controllers for controlling communication in the communication network 10. The plurality of machine learning based controllers will be described later in detail.

For example, the control apparatus 100 is a network device (for example, a proxy server, a gateway, a router, a switch, and/or the like) that transfers data in the communication network 10.

Note that the control apparatus 100 is not limited to the network device that transfers data in the communication network 10. This will be described later in detail as a fourth example alteration of the first example embodiment.

<2.2. Configuration of Control Apparatus>

(1) Functional Configuration

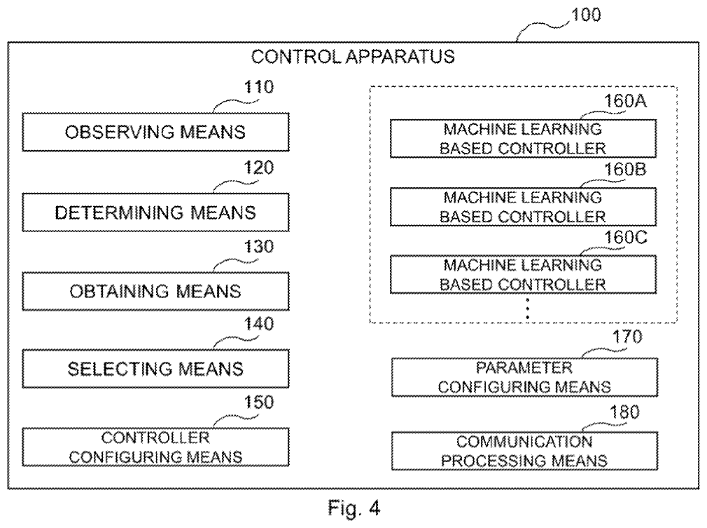

FIG. 4 is a block diagram illustrating an example of a schematic functional configuration of the control apparatus 100 according to the first example embodiment. With reference to FIG. 4, the control apparatus 100 includes an observing means 110, a determining means 120, an obtaining means 130, a selecting means 140, a controller configuring means 150, a plurality of machine learning based controllers 160 (machine learning based controllers 160A, 160B, 160C, and the like) (for example, N machine learning based controllers 160), a parameter configuring means 170, and a communication processing means 180.

The operations of each of the observing means 110, the determining means 120, the obtaining means 130, the selecting means 140, the controller configuring means 150, the machine learning based controllers 160, the parameter configuring means 170, and the communication processing means 180 will be described later.

Note that, when the machine learning based controllers 160 need to be distinguished, the machine learning based controllers 160 may be expressed as, for example, as illustrated in FIG. 4, “machine learning based controller 160A”, “machine learning based controller 160B”, “machine learning based controller 160C”, and the like. In contrast, when the machine learning based controllers 160 need not be distinguished, the machine learning based controllers 160 are simply expressed as “machine learning based controller 160”.

(2) Hardware Configuration

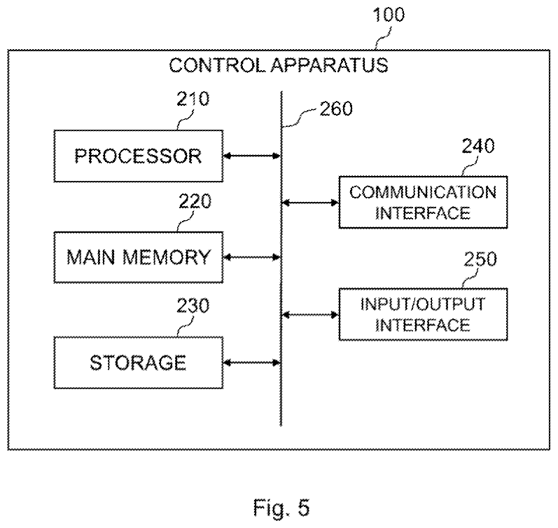

FIG. 5 is a block diagram illustrating an example of a schematic hardware configuration of the control apparatus 100 according to the first example embodiment. With reference to FIG. 5, the control apparatus 100 includes a processor 210, a main memory 220, a storage 230, a communication interface 240, and an input/output interface 250. The processor 210, the main memory 220, the storage 230, the communication interface 240, and the input/output interface 250 are connected to each other via a bus 260.

The processor 210 executes a program read from the main memory 220. As an example, the processor 210 is a central processing unit (CPU).

The main memory 220 stores a program and various pieces of data. As an example, the main memory 220 is a random access memory (RAM).

The storage 230 stores a program and various pieces of data. As an example, the storage 230 includes a solid state drive (SSD) and/or a hard disk drive (HDD).

The communication interface 240 is an interface for communication with another apparatus. As an example, the communication interface 240 is a network adapter or a network interface card.

The input/output interface 250 is an interface for connection with an input apparatus such as a keyboard, and an output apparatus such as a display.

Each of the observing means 110, the determining means 120, the obtaining means 130, the selecting means 140, the controller configuring means 150, the machine learning based controller 160, the parameter configuring means 170, and the communication processing means 180 may be implemented with the processor 210 and the main memory 220, or may be implemented with the processor 210, the main memory 220 and the communication interface 240.

As a matter of course, the hardware configuration of the control apparatus 100 is not limited to the example described above. The control apparatus 100 may be implemented with another hardware configuration.

Alternatively, the control apparatus 100 may be virtualized. In other words, the control apparatus 100 may be implemented as a virtual machine. In this case, the control apparatus 100 (virtual machine) may operate as a physical machine (hardware) including a processor, a memory, and the like, and a virtual machine on a hypervisor. As a matter of course, the control apparatus 100 (virtual machine) may be distributed into a plurality of physical machines for operation.

The control apparatus 100 may include a memory (main memory 220) that stores a program (instructions), and one or more processors (processors 210) that can execute the program (instructions). The one or more processors may execute the program to perform the operations of the observing means 110, the determining means 120, the obtaining means 130, the selecting means 140, the controller configuring means 150, the machine learning based controller 160, the parameter configuring means 170, and/or the communication processing means 180. The program may be a program for causing the processor(s) to execute the operations of the observing means 110, the determining means 120, the obtaining means 130, the selecting means 140, the controller configuring means 150, the machine learning based controller 160, the parameter configuring means 170, and/or the communication processing means 180.

<2.3. Features of Machine Learning Based Controller>

Each of the plurality of machine learning based controllers 160 (for example, N machine learning based controllers 160) is a machine learning based controller for controlling communication in the communication network 10.

(1) Operation of Machine Learning Based Controller 160

For example, each of the plurality of machine learning based controllers 160 is a reinforcement learning based controller. In this case, each of the plurality of machine learning based controllers 160 operates as an agent of reinforcement learning, and outputs an action, based on an input state, for example.

For example, the communication network 10 corresponds to “environment” of reinforcement learning, and a state of the communication network 10 corresponds to “state” of reinforcement learning (in other words, input of reinforcement learning). For example, a change of a control parameter of the communication network 10 (for example, increase or decrease of the control parameter of the communication network 10, or a change of the control parameter of the communication network 10 to a specific value) corresponds to “action” of reinforcement learning (in other words, output of reinforcement learning). In other words, the machine learning based controller 160 selects a change of the control parameter of the communication network 10 from the observed state of the communication network 10. The machine learning based controller 160 obtains a reward through selection of a change of the control parameter of the communication network 10 (“action” of reinforcement learning). Note that it can also be said that the state of the communication network 10 is a state of communication in the communication network 10.

As described above, for example, the control apparatus 100 is a network device (for example, a proxy server, a gateway, a router, a switch, and/or the like) that transfers data in the communication network 10. In this case, for example, the machine learning based controller 160 selects a change of the control parameter of the control apparatus 100 from the state of the communication network 10 observed in the control apparatus 100, and outputs the change. The control apparatus 100 (parameter configuring means 170) configures the changed control parameter in the control apparatus 100 according to the selected change of the control parameter. As a result, the control apparatus 100 (communication processing means 180) transfers data (for example, packets) according to the changed control parameter. In this manner, the machine learning based controller 160 controls communication in the communication network 10 by, for example, selecting a change of the control parameter.

Note that the control apparatus 100 is not limited to the network device that transfers data in the communication network 10. This will be described later in detail as the fourth example alteration of the first example embodiment.

According to the operation of the machine learning based controller 160 as described above, for example, the control parameter can be automatically configured.

(2) Examples of “State” and “Action” of Reinforcement Learning

As described above, for example, the state of the communication network 10 corresponds to “state” of reinforcement learning (in other words, input of reinforcement learning), and the change of the control parameter of the communication network 10 corresponds to “action” of reinforcement learning (in other words, output of reinforcement learning). Here, further specific examples of “state” and “action” of reinforcement learning will be described.

### First Example

As a first example, the machine learning based controller 160 is used for control of a Transmission Control Protocol (TCP) flow in the communication network 10. In this case, “state” and “action” of reinforcement learning is, for example, as follows:

[State] Number of active flows, Available band and/or
Previous buffer size of Internet Protocol (IP)

[Action] Increase or decrease of transmission buffer size

### Second Example

As a second example, the machine learning based controller 160 is used for control of a flow rate of video traffic in the communication network 10. In this case, “state” and “action” of reinforcement learning is, for example, as follows:

[State] Quality of Experience (QoE) of video
(For example, a bit rate of a video and/or resolution of a video)

[Action] Upper limit increase or decrease of throughput

### Third Example

As a third example, the machine learning based controller 160 is used for robot control. In this case, “state” and “action” of reinforcement learning is, for example, as follows:

[State] Packet arrival interval and/or statistical value of packet size
(For example, a maximum value, a minimum value, an average value, a standard deviation, or the like)

[Action] Increase or decrease of packet transmission interval

Additional Notes

As a matter of course, “state” and “action” of reinforcement learning according to the first example embodiment are not limited to the examples described above.

As described above, “state” of reinforcement learning is the state of the communication network 10, for example, but may more specifically be a state of any protocol layer (TCP, User Datagram Protocol (UDP), IP, or Medium Access Control (MAC)) of the communication network 10.

“Action” of reinforcement learning corresponds to the change of the control parameter of the communication network 10, for example, but may more specifically correspond to a change of the control parameter of any protocol layer (TCP, UDP, IP, or MAC) of the communication network 10.

Note that, for example, the plurality of machine learning based controllers 160 have the same form of state as input of reinforcement learning, and the same form of action as output of reinforcement learning. Note that the first example embodiment is not limited to the example described above. This will be described later in detail as a first example alteration of the first example embodiment.

(3) Difference Between Machine Learning Based Controllers 160

For example, each of the plurality of machine learning based controllers 160 includes a learning condition different from a learning condition of one or more other machine learning based controllers 160 included in the plurality of machine learning based controllers 160. In other words, there is a difference in the learning conditions among the plurality of machine learning based controllers 160.

More specifically, for example, each of the plurality of machine learning based controllers 160 includes a learning condition different from all of the other machine learning based controllers 160 included in the plurality of machine learning based controllers 160. In other words, each of the plurality of machine learning based controllers 160 includes a unique learning condition. For example, each of the plurality of machine learning based controllers 160 includes a unique learning condition suitable for a target state (for example, a target congestion state) of the communication network 10. In other words, the machine learning based controller 160 included in the plurality of machine learning based controllers 160 includes a learning condition according to the state of the communication network 10 corresponding to the machine learning based controller 160.

Owing to the machine learning based controllers 160 including different learning conditions, for example, learning and control suitable for various states of the communication network 10 can be performed.

(4) Learning Condition

For example, the learning condition includes at least one of a lower limit of probability of exploration in reinforcement learning, a change amount of the parameter in reinforcement learning, and a configuration of a neural network in reinforcement learning.

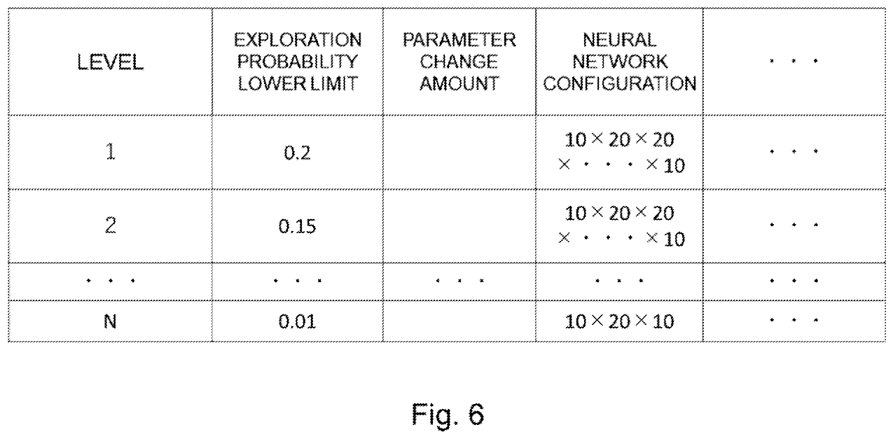

FIG. 6 is a diagram for illustrating an example of the learning condition of each machine learning based controller 160 according to the first example embodiment. With reference to FIG. 6, the learning condition of each of the N machine learning based controllers 160 is illustrated. The learning condition includes an exploration probability lower limit, a parameter change amount, and a neural network configuration.

The exploration probability lower limit is a lower limit of probability of exploration in reinforcement learning. As described above, in reinforcement learning, learning is performed with “exploitation” and “exploration”, and in the Epsilon-Greedy method, for example, “exploration” is selected with probability ε, and “exploitation” is selected with probability 1−ε. In such a case, the exploration probability lower limit is a lower limit of the probability ε. As an example, regarding the machine learning based controller 160 of level 1 of FIG. 6, the exploration probability lower limit is 0.2, and thus the probability ε is 0.2 or higher.

The parameter change amount is a change amount of the parameter in reinforcement learning. As described above, for example, the action of the reinforcement learning is the change of the control parameter of the communication network 10, and the parameter change amount is an amount of changing the control parameter as the action of reinforcement learning. For example, if the parameter change amount is large, the control parameter can be brought significantly closer to an optimal value, and if the parameter change amount is small, the control parameter can be brought to the optimal value finely.

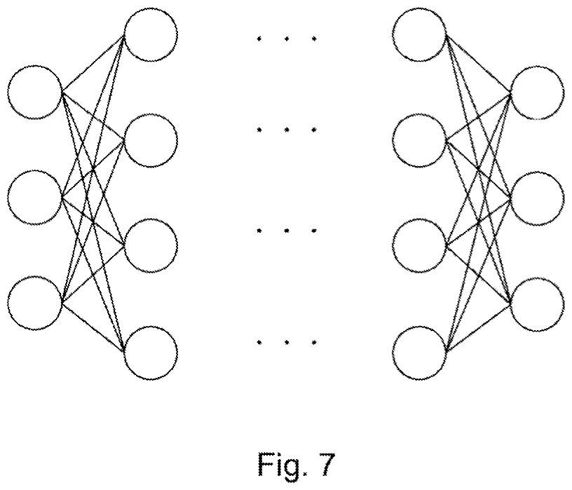

The neural network configuration is a configuration of a neural network in reinforcement learning. FIG. 7 is a diagram for illustrating an example of a configuration of a neural network according to the first example embodiment. With reference to FIG. 7, the neural network includes a plurality of layers. For example, by increasing the number of layers in the neural network, a complicated relationship between input (specifically, state) and output (specifically, action) can be more appropriately expressed. For example, by reducing the number of layers in the neural network (making the layers shallow), the relationship between input (specifically, state) and output (specifically, action) can be expressed through less calculation.

(5) Number of Machine Learning Based Controllers 160

For example, the control apparatus 100 (controller configuring means 150) determines the number (for example, N) of machine learning based controllers 160 for controlling communication in the communication network 10.

Method of Determination

For example, the control apparatus 100 (controller configuring means 150) determines the number (for example, N) of machine learning based controllers 160, based on results of observation of the communication network 10 (for example, a range of congestion level in the communication network 10).

Alternatively, the control apparatus 100 (controller configuring means 150) may determine the number (for example, N) of machine learning based controllers 160, based on information configured by a person in order to use the control apparatus 100 in the communication network 10 (for example, information indicating the number of machine learning based controllers 160).

Note that the method of determination of the number of machine learning based controllers 160 is not limited to the examples described above.

Timing of Determination

For example, the control apparatus 100 (controller configuring means 150) determines the number (for example, N) of machine learning based controllers 160 in advance before start of use of the machine learning based controllers 160.

In addition or alternatively, the control apparatus 100 (controller configuring means 150) may determine the number (for example, N) of machine learning based controllers 160 after start of use of the machine learning based controllers 160. As an example, when the configuration of the communication network 10 is changed, for example, the control apparatus 100 (controller configuring means 150) may determine the number (for example, N) of machine learning based controllers 160. As another example, when learning in the machine learning based controller 160 is not appropriately converged, the control apparatus 100 (controller configuring means 150) may determine the number (for example, N) of machine learning based controllers 160.

Processing after Determination

For example, a large number of machine learning based controllers 160 are prepared in advance. In this case, for example, the control apparatus 100 (controller configuring means 150) activates N machine learning based controllers 160 of the large number of machine learning based controllers 160 after determination of the number (N) of machine learning based controllers 160.

Alternatively, the control apparatus 100 (controller configuring means 150) may generate N machine learning based controllers 160 after determination of the number (N) of machine learning based controllers 160.

For example, as described above, the number of machine learning based controllers 160 is determined. In this manner, for example, the number of machine learning based controllers 160 suitable for the communication network 10 can be selectively used. As a result, for example, communication of the communication network 10 can be more appropriately controlled.

(6) Implementation

As an example, the plurality of machine learning based controllers 160 (for example, the N machine learning based controllers 160) are implemented as separate pieces of software.

As another example, the plurality of machine learning based controllers 160 may be implemented with common software and separate libraries.

As yet another example, the plurality of machine learning based controllers 160 may be implemented as separate pieces of hardware.

<2.4. Selection of Machine Learning Based Controller>

The control apparatus 100 (selecting means 140) selects one of the plurality of machine learning based controllers 160 for controlling communication in the communication network 10. In other words, the control apparatus 100 (selecting means 140) selects one machine learning based controller 160 used for control of communication in the communication network 10 out of the plurality of machine learning based controllers 160.

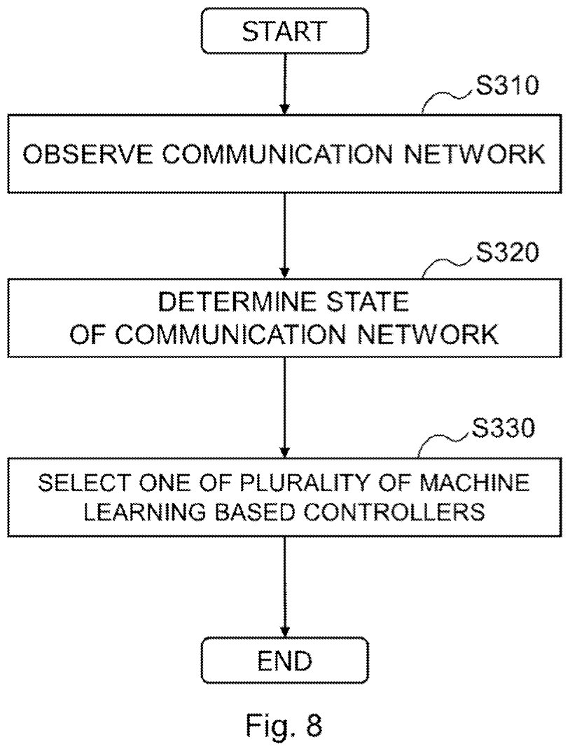

FIG. 8 is a flowchart for illustrating an example of a general flow of controller selection processing according to the first example embodiment. In the following, with reference to FIG. 8, operation for selection of the machine learning based controller 160 will be described.

(1) Observation (S310)

For example, the control apparatus 100 (observing means 110) observes the communication network 10 (S310).

More specifically, for example, the control apparatus 100 (observing means 110) observes throughput in the communication network 10 and/or a packet loss rate in the communication network 10. For example, the control apparatus 100 is a network device that transfers data in the network device that transfers data in the communication network 10, and the throughput to be observed is throughput in the control apparatus 100, and the packet loss rate to be observed is a packet loss rate in the control apparatus 100.

For example, the control apparatus 100 (observing means 110) generates observation information regarding the communication network 10. The observation information indicates results of observation of the communication network 10. More specifically, for example, the observation information indicates throughput in the communication network 10 and/or a packet loss rate in the communication network 10.

(2) Determination (S320)

For example, the control apparatus 100 (determining means 120) determines a state of the communication network 10 (S320).

State of Communication Network 10

For example, the state to be determined is a congestion state of the communication network 10. In other words, the control apparatus 100 (determining means 120) determines a congestion state of the communication network 10.

More specifically, for example, the congestion state to be determined is a congestion level of the communication network 10. In other words, the control apparatus 100 (determining means 120) determines a congestion level of the communication network 10. As an example, as the congestion level, levels from 1 to N are defined in advance, and the control apparatus 100 (determining means 120) determines which the congestion level of the communication network 10 is among the levels of 1 to N.

Note that the state determined here (state of the communication network 10) is merely a state determined for selection of the machine learning based controller 160, and does not mean “state” being input of reinforcement learning of the machine learning based controller 160.

Determination Method

For example, the control apparatus 100 (determining means 120) determines the state of the communication network 10, based on the observation information.

As described above, for example, the observation information indicates throughput in the communication network 10 and/or a packet loss rate in the communication network 10. In this case, the control apparatus 100 (determining means 120) determines the state of the communication network 10 (for example, the congestion level), based on the throughput in the communication network 10 and/or the packet loss rate in the communication network 10.

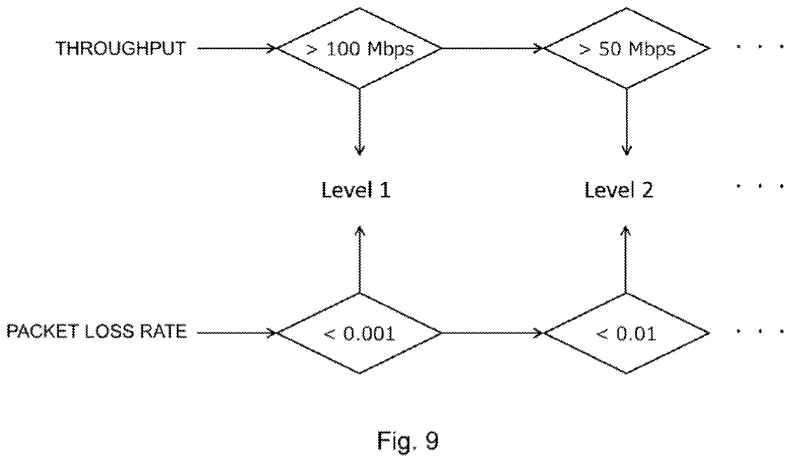

FIG. 9 is a diagram for illustrating an example of a method of determination of the state of the communication network 10 according to the first example embodiment. When the congestion level is determined based on throughput, the congestion level is determined as level 1 if the throughput is greater than 100 Mbps, and the congestion level is determined as level 2 if the throughput is greater than 50 Mbps and equal to or less than 100 Mbps. In contrast, when the congestion level is determined based on the packet loss rate, the congestion level is determined as level 1 if the packet loss rate is less than 0.001, and the congestion level is determined as level 2 if the packet loss rate is equal to or greater than 0.001 and less than 0.01.

In the example of FIG. 9, the congestion level may be determined based on both of the throughput and the packet loss rate. In this case, as an example, the higher level out of the level determined based only on the throughput and the level determined based only on the packet loss rate may be determined as the congestion level.

In the example of FIG. 9, a higher level means severer congestion.

Note that the method of determining the state of the communication network 10 is not limited to the example described above. Other examples of the determination method will be described later in detail as a second example alteration of the first example embodiment.

State Information

For example, the control apparatus 100 (determining means 120) generates state information related to the state of the communication network 10 (in other words, the determined state).

For example, the state information indicates the state of the communication network 10 (in other words, the determined state). More specifically, for example, the state information indicates the congestion level of the communication network 10 (in other words, the determined congestion level).

Note that the state information is not limited to the example described above. This will be described later in detail as a third example alteration of the first example embodiment.

(3) Selection (S330)

The control apparatus 100 (obtaining means 130) obtains the state information. The control apparatus 100 (selecting means 140) selects one of the plurality of machine learning based controllers 160, based on the state information (S330). In other words, the control apparatus 100 (selecting means 140) selects one machine learning based controller 160 used for control of communication in the communication network 10 out of the plurality of machine learning based controllers 160, based on the state information. In other words, the control apparatus 100 (selecting means 140) switches the machine learning based controller 160 used for control of communication in the communication network 10, based on the state information. Through the selection as above, the plurality of machine learning based controllers are selectively used for control of communication in the communication network 10.

For example, the plurality of machine learning based controllers 160 correspond to different states (for example, different congestion levels) of the communication network 10. In this case, the control apparatus 100 (selecting means 140) selects the machine learning based controller 160 corresponding to the state (the congestion level) of the communication network 10 indicated by the state information.

Specifically, for example, as illustrated in FIG. 6, the plurality of machine learning based controllers 160 are N machine learning based controllers 160 respectively corresponding to the congestion levels of 1 to N. In this case, the control apparatus 100 (selecting means 140) selects the machine learning based controller 160 corresponding to the congestion level indicated by the state information. As illustrated in FIG. 6, the machine learning based controller 160 corresponding to a higher congestion level has a higher exploration probability lower limit, ad has a neural network configuration with more layers.

As described above, for each state (for example, congestion level) of the communication network, the machine learning based controller 160 is prepared and is selectively used. Thus, each machine learning based controller 160 is used only for a target state (for example, congestion level), and can perform learning and control dedicated to the target state (for example, congestion level). Thus, even when the state (for example, the congestion level) of the communication network changes, in each machine learning based controller 160, an optimal control parameter is detected without requiring a large amount of time, and the control parameter can converge. Accuracy of the converged control parameter can be increased. In this manner, control suitable for the state of the communication network (in other words, the communication environment) can be more easily performed in the communication network 10.

Note that the selected machine learning based controller 160 is used for control of communication in the communication network 10. Specifically, for example, as described above, the selected machine learning based controller 160 selects a change of the control parameter based on an input state of the communication network 10, and configures the changed control parameter in the control apparatus 100, for example.

<2.5. Example Alterations>

First to fifth example alterations of the first example embodiment will be described. Note that two or more example alterations of the first to fifth example alterations may be combined.

(1) First Example Alteration

As described above, for example, the plurality of machine learning based controllers 160 have the same form of state as input of reinforcement learning, and the same form of action as output of reinforcement learning. In other words, there is no difference in the forms of the state and the action of reinforcement learning among the plurality of machine learning based controllers 160. However, the first example embodiment is not limited to the example described above.

Difference of Input States

In the first example alteration of the first example embodiment, each of the plurality of machine learning based controllers 160 may have a state of a form different from a form for one or more other machine learning based controllers 160 included in the plurality of machine learning based controllers 160 as input of reinforcement learning. In other words, there may be a difference in the forms of the state of reinforcement learning among the plurality of machine learning based controllers 160.

As an example, the state of a different form may be a state of a different amount. In other words, there may be a difference in the amounts of the state of reinforcement learning among the plurality of machine learning based controllers 160. Specifically, for example, the machine learning based controller 160A may have a state (in other words, one state) obtained through one most recent observation as input of reinforcement learning, and the machine learning based controller 160B may have states (in other words, two states of the same type) obtained through two most recent observations as input of reinforcement learning.

Difference of Output Actions

In the first example alteration of the first example embodiment, each of the plurality of machine learning based controllers 160 may have an action of a form different from a form for one or more other machine learning based controllers 160 included in the plurality of machine learning based controllers 160 as output of reinforcement learning. In other words, there may be a difference in the forms of the action of reinforcement learning among the plurality of machine learning based controllers 160.

As an example, the action of a different form may be a change of a different control parameter of the communication network 10. In other words, there may be a difference in the control parameters changed as the action among the plurality of machine learning based controllers 160. Specifically, for example, the machine learning based controller 160A may have a change of the transmission buffer size as the action of reinforcement learning, and the machine learning based controller 160B may have a change of the transmission buffer size and the throughput as the action of reinforcement learning.

Difference between Machine Learning Based Controllers 160

In the first example alteration of the first example embodiment, each of the plurality of machine learning based controllers 160 may be different from each of all of the other machine learning based controllers 160 in any one of a learning condition, the form of the state of reinforcement learning, and the form of the action of reinforcement learning. In other words, each of the plurality of machine learning based controllers 160 may be unique among the plurality of machine learning based controllers 160 from the aspect of a combination of the learning condition, the form of the state of reinforcement learning, and the form of the action of reinforcement learning.

(2) Second Example Alteration

As described above, for selection of the machine learning based controller 160, for example, the control apparatus 100 (determining means 120) determines the state of the communication network 10, based on the observation information regarding the communication network 10. However, determination according to the first example embodiment is not limited to the example described above.

In the second example alteration of the first example embodiment, the control apparatus 100 (determining means 120) may determine the state of the communication network 10, based on information indicating the state of the communication network 10 for each time frame (hereinafter referred to as “time frame state information”).

As an example, the time frame state information indicates level N (level meaning the severest congestion) as the congestion level of a time frame from 12 pm to 1 pm (time frame in which the communication networks 10 is congested). Although it is not explicitly described here, as a matter of course, the time frame state information also indicates a congestion level of another time frame.

For example, the time frame state information is determined in advance, and is stored in the control apparatus 100. The time frame state information may be determined in advance manually, or may be determined in advance automatically based on statistical information.

Through determination as described above, the state of the communication network 10 can be determined without observation of the communication network 10.

(3) Third Example Alteration

As described above, for selection of the machine learning based controller 160, state information related to the state of the communication network 10 is used, and for example, the state information indicates the state of the communication network 10. However, the state information according to the first example embodiment is not limited to the example described above.

In the third example alteration of the first example embodiment, the state information need not indicate the state itself of the communication network 10. For example, the state information may be information corresponding to the state of the communication network 10, although not indicating the state itself of the communication network 10.

As an example, the state information may be an index corresponding to the congestion level of the communication network 10, although not indicating the congestion level itself of the communication network 10.

(4) Fourth Example Alteration

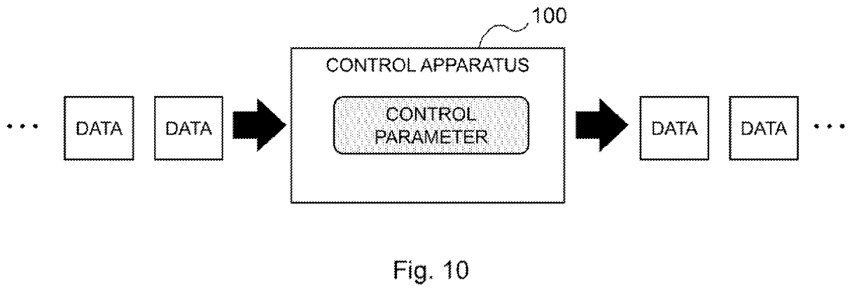

As described above, for example, the control apparatus 100 is a network device that transfers data in the communication network 10 (for example, a proxy server, a gateway, a router, a switch, and/or the like) (see FIG. 10). As described above, for example, when the machine learning based controller 160 selects a change of the control parameter, the control apparatus 100 (parameter configuring means 170) configures the changed control parameter in the control apparatus 100 (see FIG. 10). However, the control apparatus 100 according to the first example embodiment is not limited to the example described above.

### First Example

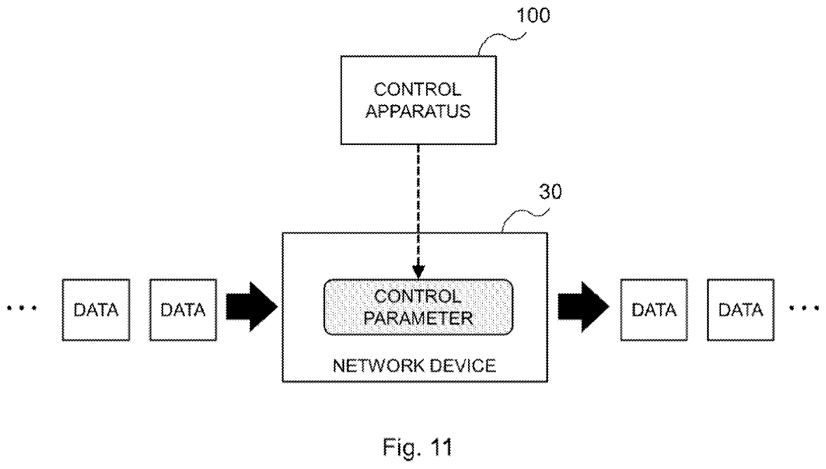

In the fourth example alteration of the first example embodiment, as a first example, as illustrated in FIG. 11, the control apparatus 100 may be an apparatus (for example, a network controller) that controls a network device 30 that transfers data in the communication network 10, instead of a network device itself that transfers data in the communication network 10.

The network device 30 may observe the communication network 10, without the control apparatus 100 (observing means 110) itself observing the communication network 10. The control apparatus 100 (observing means 110) may obtain observation information regarding the communication network 10 from the network device 30.

As illustrated in FIG. 11, when the machine learning based controller 160 selects a change of the control parameter, the control apparatus 100 (parameter configuring means 170) may cause the network device 30 to configure the changed control parameter. As an example, the control apparatus 100 (parameter configuring means 170) may transmit parameter information indicating the change of the control parameter (for example, a command for instructing a change of the control parameter) to the network device 30, and the network device 30 may configure the changed control parameter, based on the parameter information. As a result, the network device 30 may transfer data (for example, packets) according to the changed control parameter.

### Second Example

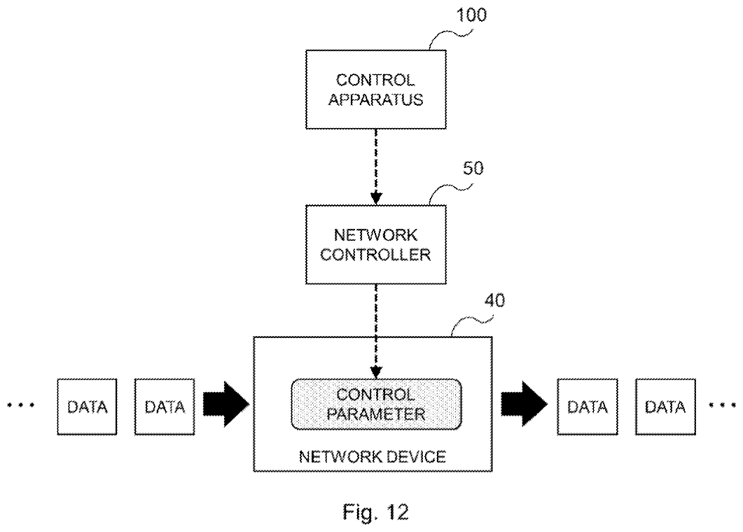

As a second example, as illustrated in FIG. 12, a network controller 50 may control a network device 40 that transfers data in the communication network 10, and the control apparatus 100 may be an apparatus that controls or assists the network controller 50.

The network device 40 may observe the communication network 10, without the control apparatus 100 (observing means 110) itself observing the communication network 10. The control apparatus 100 (observing means 110) may obtain observation information regarding the communication network 10 from the network device 40 or the network controller 50.

As illustrated in FIG. 12, when the machine learning based controller 160 selects a change of the control parameter, the control apparatus 100 (parameter configuring means 170) may transmit first parameter information indicating a change of the control parameter (for example, a command for instructing a change of the control parameter, or assist information for teaching a change of the control parameter) to the network controller 50. In addition, the network controller 50 may transmit second parameter information indicating a change of the control parameter, based on the first parameter information (for example, a command for instructing a change of the control parameter) to the network device 40, and the network device 40 may configure the changed control parameter, based on the second parameter information. As a result, the network device 40 may transfer data (for example, packets) according to the changed control parameter.

### Third Example

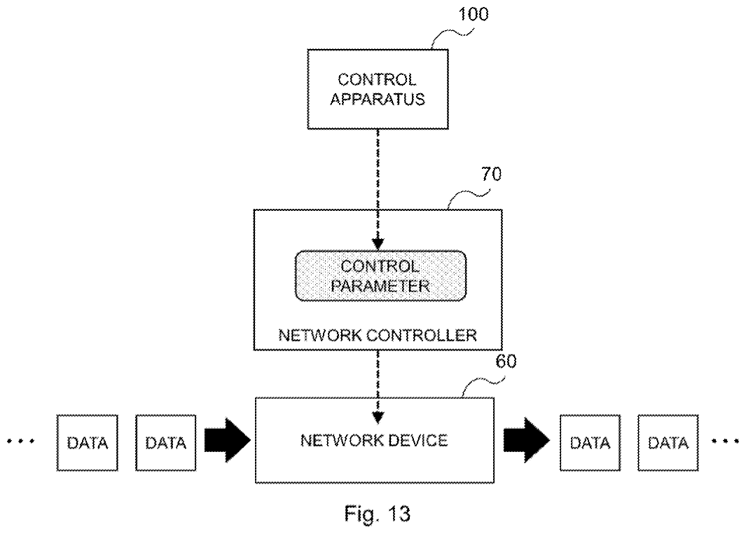

As a third example, as illustrated in FIG. 13, a network controller 70 may control a network device 60 that transfers data in the communication network 10, and the control apparatus 100 may be an apparatus that controls the network controller 70.

The network device 60 may observe the communication network 10, without the control apparatus 100 (observing means 110) itself observing the communication network 10. The control apparatus 100 (observing means 110) may obtain observation information regarding the communication network 10 from the network device 60 or the network controller 70.

As illustrated in FIG. 13, when the machine learning based controller 160 selects a change of the control parameter, the control apparatus 100 (parameter configuring means 170) may cause the network controller 70 to configure the changed control parameter. As an example, the control apparatus 100 (parameter configuring means 170) may transmit parameter information indicating the change of the control parameter (for example, a command for instructing a change of the control parameter) to the network controller 70, and the network controller 70 may configure the changed control parameter based on the parameter information. As a result, the network controller 70 may control the network device 60 according to the changed control parameter, and the network device 60 may transfer data (for example, packets) according to control by the network controller 70.

(5) Fifth Example Alteration

As described above, for example, the control apparatus 100 includes the observing means 110, the determining means 120, the obtaining means 130, the selecting means 140, the controller configuring means 150, the plurality of machine learning based controllers 160, the parameter configuring means 170, and the communication processing means 180. However, the control apparatus 100 according to the first example embodiment is not limited to the example described above.

In the fifth example alteration of the first example embodiment, for example, the observing means 110 may be included in another apparatus instead of being included in the control apparatus 100. In this case, the control apparatus 100 may receive observation information regarding the communication network 10 from such another apparatus. In addition, for example, the determining means 120 may also be included in such another apparatus instead of being included in the control apparatus 100. In this case, the control apparatus 100 may receive state information related to the state of the communication network 10 from such another apparatus. For example, in a case as in the fourth example alteration, the observing means 110 (and the determining means 120) may be included in another apparatus (for example, a network device or a network controller) instead of being included in the control apparatus 100.

In the fifth example alteration of the first example embodiment, for example, the controller configuring means 150 may be included in another apparatus instead of being included in the control apparatus 100. In this case, the number (for example, N) of machine learning based controllers 160 may be determined by such another apparatus.

In the fifth example alteration of the first example embodiment, for example, the plurality of machine learning based controllers 160 may be included in another apparatus instead of being included in the control apparatus 100. In this case, the control apparatus 100 may notify such another apparatus of the selected machine learning based controller 160. The parameter configuring means 170 may also be included in such another apparatus instead of being included in the control apparatus 100. Note that, when the machine learning based controller 160 is not included in the control apparatus 100, in the description in the fourth example alteration, the “control apparatus 100” may be replaced by an “apparatus including the machine learning based controller 160”.

In the fifth example alteration of the first example embodiment, for example, the parameter configuring means 170 may be included in each of the plurality of machine learning based controllers 160. In other words, in each of the plurality of machine learning based controllers 160, the above-described operation of the parameter configuring means 170 may be performed.

In the fifth example alteration of the first example embodiment, for example, the communication processing means 180 that transfers data (for example, packets) may be included in another apparatus instead of being included in the control apparatus 100. For example, in a case as in the fourth example alteration, the communication processing means 180 may be included in a network device instead of being included in the control apparatus 100.

### 3. Second Example Embodiment

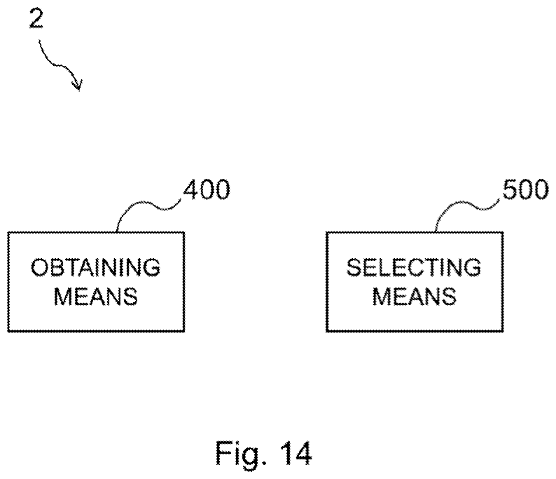

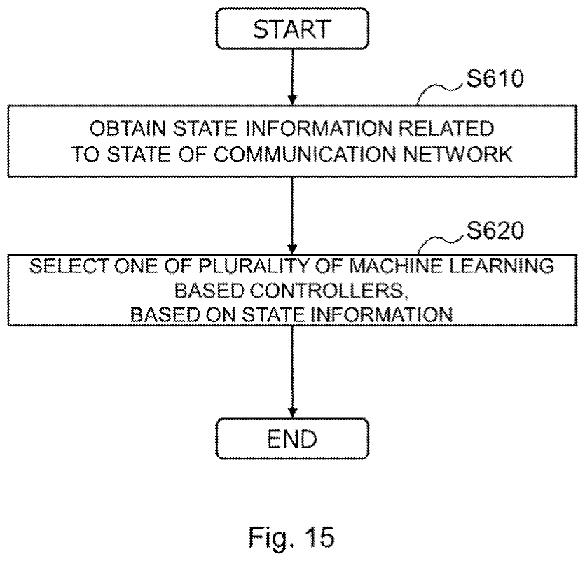

Next, with reference to FIG. 14 and FIG. 15, a second example embodiment of the present disclosure will be described. The above-described first example embodiment is a concrete example embodiment, whereas the second example embodiment is a more generalized example embodiment.

FIG. 14 illustrates an example of a schematic configuration of a system 2 according to the second example embodiment. With reference to FIG. 14, the system 2 includes an obtaining means 400 and a selecting means 500.

FIG. 15 is a flowchart for illustrating an example of a general flow of controller selection processing according to the second example embodiment.

The obtaining means 400 obtains state information related to a state of the communication network (S610).

The selecting means 500 selects one of the plurality of machine learning based controllers for controlling communication in the communication network, based on the state information (S620).

Description regarding the communication network, the state of the communication network, the state information, and the plurality of machine learning based controllers is the same as the description regarding these in the first example embodiment, for example. Description regarding selection of the machine learning based controller is also the same as the description in the first example embodiment, for example. Thus, overlapping description will be omitted here. Note that, as a matter of course, the second example embodiment is not limited to the example of the first example embodiment.

As described above, the machine learning based controller is selected. With this, communication control suitable for a communication environment can be more easily performed in a communication network.

Descriptions have been given above of the example embodiments of the present disclosure. However, the present disclosure is not limited to these example embodiments. It should be understood by those of ordinary skill in the art that these example embodiments are merely examples and that various alterations are possible without departing from the scope and the spirit of the present disclosure.

For example, the steps in the processing described in the Specification may not necessarily be executed in time series in the order described in the flowcharts. For example, the steps in the processing may be executed in order different from that described in the flowcharts or may be executed in parallel. Some of the steps in the processing may be deleted, or more steps may be added to the processing.

Moreover, a method including processing of the constituent elements of the system or the control apparatus described in the Specification may be provided, and programs for causing a processor to execute the processing of the constituent elements may be provided. Moreover, a non-transitory computer readable recording medium (non-transitory computer readable recording media) having recorded thereon the programs may be provided. It is apparent that such methods, programs, and non-transitory computer readable recording media are also included in the present disclosure.

The whole or part of the example embodiments disclosed above can be described as, but not limited to, the following supplementary notes.

### (Supplementary Note 1)

A system comprising:

an obtaining means for obtaining state information related to a state of a communication network; and

a selecting means for selecting one of a plurality of machine learning based controllers for controlling communication in the communication network, based on the state information.

### (Supplementary Note 2)

The system according to supplementary note 1, wherein the state information indicates the state of the communication network.

### (Supplementary Note 3)

The system according to supplementary note 1 or 2, wherein the state of the communication network is a congestion state of the communication network.

### (Supplementary Note 4)

The system according to supplementary note 3, wherein the congestion state of the communication network is a congestion level of the communication network.

### (Supplementary Note 5)

The system according to any one of supplementary notes 1 to 4, further comprising a determining means for determining the state of the communication network.

### (Supplementary Note 6)

The system according to supplementary note 5, wherein the determining means determines the state of the communication network, based on observation information regarding the communication network.

### (Supplementary Note 7)

The system according to supplementary note 6, wherein the observation information indicates throughput in the communication network or a packet loss rate in the communication network.

### (Supplementary Note 8)

The system according to supplementary note 5, wherein the determining means determines the state of the communication network, based on information indicating the state of the communication network for each time frame.

### (Supplementary Note 9)

The system according to any one of supplementary notes 1 to 8, wherein a machine learning based controller included in the plurality of machine learning based controllers includes a learning condition according to the state of the communication network corresponding to the machine learning based controller.

### (Supplementary Note 10)

The system according to any one of supplementary notes 1 to 9, wherein each of the plurality of machine learning based controllers includes a learning condition different from a learning condition of one or more other machine learning based controllers included in the plurality of machine learning based controllers.

### (Supplementary Note 11)

The system according to supplementary note 9 or 10, wherein

each of the plurality of machine learning based controllers is a reinforcement learning based controller, and

the learning condition includes at least one of a lower limit of probability of exploration in reinforcement learning, a change amount of a parameter in the reinforcement learning, and a configuration of a neural network in the reinforcement learning.

### (Supplementary Note 12)

The system according to any one of supplementary notes 1 to 11, wherein

each of the plurality of machine learning based controllers is a reinforcement learning based controller configured to output an action based on an input state, and

each of the plurality of machine learning based controllers has the state of a form different from a form for one or more other machine learning based controllers included in the plurality of machine learning based controllers as input of the reinforcement learning.

### (Supplementary Note 13)

The system according to any one of supplementary notes 1 to 12, wherein

each of the plurality of machine learning based controllers is a reinforcement learning based controller configured to output an action based on an input state, and

each of the plurality of machine learning based controllers has the action of a form different from a form for one or more other machine learning based controllers included in the plurality of machine learning based controllers as output of the reinforcement learning.

### (Supplementary Note 14)

The system according to any one of supplementary notes 10 to 13, wherein the one or more other machine learning based controllers are all of other machine learning based controllers included in the plurality of machine learning based controllers.

### (Supplementary Note 15)

The system according to any one of supplementary notes 1 to 14, further comprising a controller configuring means for determining the number of machine learning based controllers included in the plurality of machine learning based controllers.

### (Supplementary Note 16)

A method comprising:
obtaining state information related to a state of a communication network; and

selecting one of a plurality of machine learning based controllers for controlling communication in the communication network, based on the state information.

### (Supplementary Note 17)

The method according to supplementary note 16, wherein the state information indicates the state of the communication network.

### (Supplementary Note 18)

The method according to supplementary note 16 or 17, wherein the state of the communication network is a congestion state of the communication network.

### (Supplementary Note 19)

The method according to supplementary note 18, wherein the congestion state of the communication network is a congestion level of the communication network.

### (Supplementary Note 20)

The method according to any one of supplementary notes 16 to 19, further comprising determining the state of the communication network.

### (Supplementary Note 21)

The method according to any one of supplementary notes 16 to 20, further comprising determining the state of the communication network, based on observation information regarding the communication network.

### (Supplementary Note 22)

The method according to supplementary note 21, wherein the observation information indicates throughput in the communication network or a packet loss rate in the communication network.

### (Supplementary Note 23)

The method according to any one of supplementary notes 16 to 20, further comprising determining the state of the communication network, based on information indicating the state of the communication network for each time frame.

### (Supplementary Note 24)

The method according to any one of supplementary notes 16 to 23, wherein a machine learning based controller included in the plurality of machine learning based controllers includes a learning condition according to the state of the communication network corresponding to the machine learning based controller.

### (Supplementary Note 25)

The method according to any one of supplementary notes 16 to 24, wherein each of the plurality of machine learning based controllers includes a learning condition different from a learning condition of one or more other machine learning based controllers included in the plurality of machine learning based controllers.

### (Supplementary Note 26)

The method according to supplementary note 24 or 25, wherein

each of the plurality of machine learning based controllers is a reinforcement learning based controller, and

the learning condition includes at least one of a lower limit of probability of exploration in reinforcement learning, a change amount of a parameter in the reinforcement learning, and a configuration of a neural network in the reinforcement learning.

### (Supplementary Note 27)

The method according to any one of supplementary notes 16 to 26, wherein

each of the plurality of machine learning based controllers is a reinforcement learning based controller configured to output an action based on an input state, and

each of the plurality of machine learning based controllers has the state of a form different from a form for one or more other machine learning based controllers included in the plurality of machine learning based controllers as input of the reinforcement learning.

### (Supplementary Note 28)

The method according to any one of supplementary notes 16 to 27, wherein

each of the plurality of machine learning based controllers is a reinforcement learning based controller configured to output an action based on an input state, and

each of the plurality of machine learning based controllers has the action of a form different from a form for one or more other machine learning based controllers included in the plurality of machine learning based controllers as output of the reinforcement learning.

### (Supplementary Note 29)

The method according to any one of supplementary notes 25 to 28, wherein the one or more machine learning based controllers are all of other machine learning based controllers included in the plurality of machine learning based controllers.

### (Supplementary Note 30)

The method according to any one of supplementary notes 16 to 29, further comprising determining the number of machine learning based controllers included in the plurality of machine learning based controllers.

### (Supplementary Note 31)

A control apparatus comprising:

an obtaining means for obtaining state information related to a state of a communication network; and

a selecting means for selecting one of a plurality of machine learning based controllers for controlling communication in the communication network, based on the state information.

### (Supplementary Note 32)

The control apparatus according to supplementary note 31, wherein the state information indicates the state of the communication network.

### (Supplementary Note 33)

The control apparatus according to supplementary note 31 or 32, wherein the state of the communication network is a congestion state of the communication network.

### (Supplementary Note 34)

The control apparatus according to supplementary note 33, wherein the congestion state of the communication network is a congestion level of the communication network.

### (Supplementary Note 35)

The control apparatus any one of supplementary notes 31 to 34, further comprising a determining means for determining the state of the communication network.

### (Supplementary Note 36)

The control apparatus according to supplementary note 35, wherein the determining means determines the state of the communication network, based on observation information regarding the communication network.

### (Supplementary Note 37)

The control apparatus according to supplementary note 36, wherein the observation information indicates throughput in the communication network or a packet loss rate in the communication network.

### (Supplementary Note 38)

The control apparatus according to supplementary note 35, wherein the determining means determines the state of the communication network, based on information indicating the state of the communication network for each time frame.

### (Supplementary Note 39)

The control apparatus any one of supplementary notes 31 to 38, wherein a machine learning based controller included in the plurality of machine learning based controllers includes a learning condition according to the state of the communication network corresponding to the machine learning based controller.

### (Supplementary Note 40)

The control apparatus any one of supplementary notes 31 to 39, wherein each of the plurality of machine learning based controllers includes a learning condition different from a learning condition of one or more other machine learning based controllers included in the plurality of machine learning based controllers.

### (Supplementary Note 41)

The control apparatus according to supplementary note 39 or 40, wherein

each of the plurality of machine learning based controllers is a reinforcement learning based controller, and

the learning condition includes at least one of a lower limit of probability of exploration in reinforcement learning, a change amount of a parameter in the reinforcement learning, and a configuration of a neural network in the reinforcement learning.

### (Supplementary Note 42)

The control apparatus any one of supplementary notes 31 to 41, wherein

each of the plurality of machine learning based controllers is a reinforcement learning based controller configured to output an action based on an input state, and

each of the plurality of machine learning based controllers has the state of a form different from a form for one or more other machine learning based controllers included in the plurality of machine learning based controllers as input of the reinforcement learning.

### (Supplementary Note 43)

The control apparatus according to any one of supplementary notes 31 to 42, wherein

each of the plurality of machine learning based controllers is a reinforcement learning based controller configured to output an action based on an input state, and

each of the plurality of machine learning based controllers has the action of a form different from a form for one or more other machine learning based controllers included in the plurality of machine learning based controllers as output of the reinforcement learning.

### (Supplementary Note 44)

The control apparatus any one of supplementary notes 40 to 43, wherein the one or more other machine learning based controllers are all of other machine learning based controllers included in the plurality of machine learning based controllers.

### (Supplementary Note 45)

The control apparatus any one of supplementary note 31 to 44, further comprising a controller configuring means for determining the number of machine learning based controllers included in the plurality of machine learning based controllers.

### (Supplementary Note 46)

A program that causes a processor to execute:

obtaining state information related to a state of a communication network; and

selecting one of a plurality of machine learning based controllers for controlling communication in the communication network, based on the state information.

### (Supplementary Note 47)

A non-transitory computer readable recording medium storing a program that causes a processor to execute:

obtaining state information related to a state of a communication network; and

selecting one of a plurality of machine learning based controllers for controlling communication in the communication network, based on the state information.

### REFERENCE SIGNS LIST

1, 2 System
Communication Network
100 Control Apparatus
120 Determining Means
130, 400 Obtaining Means
140, 500 Selecting Means
150 Controller Configuring Means 150
160 Machine Learning Based Controller

What is claimed is:

1. A system comprising:
one or more apparatuses each including a memory storing instructions and one or more processors configured to execute the instructions, wherein
the one or more apparatuses are configured to:
obtain state information related to a state of a communication network; and
select one of a plurality of machine learning based controllers for controlling communication in the communication network, based on the state information.

2. The system according to claim 1, wherein
the state of the communication network is a congestion state of the communication network.

3. The system according to claim 1, wherein
the one or more apparatuses are further configured to determine the state of the communication network.

4. The system according to claim 1, wherein
a machine learning based controller included in the plurality of machine learning based controllers includes a learning condition according to the state of the communication network corresponding to the machine learning based controller.

5. The system according to claim 4, wherein
each of the plurality of machine learning based controllers is a reinforcement learning based controller, and
the learning condition includes at least one of a lower limit of probability of exploration in reinforcement learning, a change amount of a parameter in the reinforcement learning, and a configuration of a neural network in the reinforcement learning.

6. The system according to claim 1, wherein
the one or more apparatuses are further configured to determine a number of machine learning based controllers included in the plurality of machine learning based controllers.

7. A method comprising:
obtaining state information related to a state of a communication network; and
selecting one of a plurality of machine learning based controllers for controlling communication in the communication network, based on the state information.

8. The method according to claim 7, wherein
the state of the communication network is a congestion state of the communication network.

9. The method according to claim 7, further comprising
determining the state of the communication network.

10. The method according to claim 7, wherein
a machine learning based controller included in the plurality of machine learning based controllers includes a learning condition according to the state of the communication network corresponding to the machine learning based controller.

11. The method according to claim 10, wherein
each of the plurality of machine learning based controllers is a reinforcement learning based controller, and
the learning condition includes at least one of a lower limit of probability of exploration in reinforcement learning, a change amount of a parameter in the reinforcement learning, and a configuration of a neural network in the reinforcement learning.

12. The method according to claim 7, further comprising:
determining a number of machine learning based controllers included in the plurality of machine learning based controllers.

13. A control apparatus comprising:
a memory storing instructions; and
one or more processors configured to execute the instructions to:
obtain state information related to a state of a communication network; and
select one of a plurality of machine learning based controllers for controlling communication in the communication network, based on the state information.

14. The control apparatus according to claim 13, wherein
the state of the communication network is a congestion state of the communication network.

15. The control apparatus according to claim 13, wherein
the one or more apparatuses are further configured to execute the instructions to determine the state of the communication network.

16. The control apparatus according to claim 13, wherein
a machine learning based controller included in the plurality of machine learning based controllers includes a learning condition according to the state of the communication network corresponding to the machine learning based controller.

17. The control apparatus according to claim 16, wherein
each of the plurality of machine learning based controllers is a reinforcement learning based controller, and
the learning condition includes at least one of a lower limit of probability of exploration in reinforcement learning, a change amount of a parameter in the reinforcement learning, and a configuration of a neural network in the reinforcement learning.

18. The control apparatus according to claim 13, wherein
the one or more apparatuses are further configured to execute the instructions to determine a number of machine learning based controllers included in the plurality of machine learning based controllers.
